(19) United States
(12) Patent Application Publication
(10) Pub. No.: US 2025/0254258 A1
(43) Pub. Date: Aug. 7, 2025

(54) INFORMATION PROCESSING SYSTEM AND METHOD

(71) Applicant: CANON KABUSHIKI KAISHA, Tokyo (JP)

(72) Inventor: TETSU IMAI, Tokyo (JP)

(21) Appl. No.: 19/043,827

(22) Filed: Feb. 3, 2025

(30) Foreign Application Priority Data
Feb. 5, 2024 (JP) 2024-015993

(51) Int. Cl. H04N 1/00

(52) U.S. Cl. CPC H04N 1/00973; H04N 1/00244

(57) ABSTRACT

An information processing system includes a contract management server, a contract linkage process execution server, a settings delivery server, a smart service server, and an image forming apparatus. The contract management server manages a use contract of a smart service. The contract linkage process execution server determines the managed use contract. The settings delivery server manages settings information of the image forming apparatus. Upon determining that a period of the use contract has started or the use contract has been updated, automatically executes (1) transmission of a client delivery instruction to the settings delivery server and (2) transmission of a service delivery instruction to the smart service server.

### BACKGROUND

### Field

The present disclosure relates to an information processing system and method.

### Description of the Related Art

In recent years, various services have been provided to utilize multifunction peripherals, printers, and the like conveniently under environments of customers or the like. Examples of such services include automatic delivery services of consumables for multifunction peripherals and printers, failure prediction services, data backup services, and document management services cooperated with external cloud services. Such services are collectively referred to as “smart services” in some cases.

Normally, to use smart services, it is necessary to perform various settings on client sides such as multifunction peripherals and printers. The various settings are, for example, installation of applications necessary to use the smart services, installation of firmware appropriate for using the applications, and settings of various setting values necessary to use the smart services. Here, the smart services provide convenience for customers. However, since customers have to perform the above-described various settings, productivity, customer satisfaction, and the like may deteriorate in some cases.

There are techniques for automatically executing settings based on use contracts to reduce the effort in executing the above-described various settings. Japanese Patent Application Laid-open No. 2011-56771 discloses a technique for updating firmware of an image forming apparatus and changing setting values of the image forming apparatus in association with a change in a type of maintenance contract. Japanese Patent Application Laid-open No. 2014-216817 discloses a technique for updating settings of an information terminal without troubling a user as far as possible even when service contract information is changed. Specifically, according to the technique, a service provider registers identification information of a multifunction peripherals, identification information of services to be used, and contract period information in a contract management database when the service provider makes a contract. Accordingly, the technique disclosed in Japanese Patent Application Laid-open No. 2014-216817 enables delivery of setting to a multifunction peripheral in association with a contract.

According to the above-described techniques, setting values of image forming apparatuses can be updated automatically based on use contracts. On the other hand, to use the above-described smart services, servers or cloud sides providing smart services are required to reflect use settings. In the technique disclosed in Japanese Patent Application Laid-open No. 2014-216817, identification information of multifunction peripherals, identification information of services, and contract period information are registered in a contract management database. Accordingly, the technique realizes setting delivery to a multifunction peripheral using a smart service, but setting delivery to a server or a cloud side providing the smart service is not executed.

As examples of combination of smart services to be provided and settings of a server or a cloud side providing the smart services, for example, period backup settings including a data backup service, an ON/OFF setting, a period setting, and a setting of days of the week are exemplified. Alternatively, as an example of the combination, a data backup service and a backup format setting for selecting complete backup and differential backup can be exemplified. Alternatively, as an example of the combination, a part lifetime prediction service and a unit-by-unit notification ON/OFF setting or an alert notification reference setting can be exemplified. Alternatively, as an example of the combination, a consumable prediction delivery service and an automatic delivery ON/OFF setting, a delivery reference setting, or a payment method setting can be exemplified. Alternatively, as an example of the combination, an external cloud service document backup and an automatic backup setting or deletion setting can be exemplified.

For execution of setting delivery, a problem with how to determine setting values of each of a client such as an image forming apparatus and a server or a cloud may occur and a problem related to order control for both sides may occur. Techniques for reflecting settings in both sides of the image forming apparatus and the server or the cloud in conjunction with contracts are not realized. Furthermore, because of the lack of such techniques, manual setting of initial settings is necessary, which places a burden on users. Accordingly, techniques for allowing users to immediately receive services without imposing a burden on the users when contracts are initiated are desirable.

### SUMMARY OF THE INVENTION

Accordingly, the present disclosure enables use of smart services by reflecting setting values or the like in both an image forming apparatus and a server or a cloud when a contract has started. Accordingly, an object of the present disclosure is to enable to use a smart service immediately without imposing a burden on a user after a contract has started.

To solve the above-described problems, according to an aspect of the present disclosure, an information processing system includes a contract management server, a contract linkage process execution server, a settings delivery server, a smart service server, and an image forming apparatus. The contract management server executes a contract management function to manage a use contract of a smart service. The contract linkage process execution server executes a contract determination function that determines the managed use contract. The settings delivery server executes client settings information management function that manages settings information of the image forming apparatus. The contract linkage process execution server comprises one or more memories storing instructions, and one or more processors capable of executing the instructions causing the contract linkage process execution server. Upon determining that a period of the use contract has started or the use contract has been updated, the contract linkage process execution server automatically executes (1) transmission of a client delivery instruction to the settings delivery server and (2) transmission of a service delivery instruction to the smart service server. The client delivery instruction is based on setting information related to application and firmware required on the image forming apparatus to use the smart service. The service delivery instruction is based on service request settings to be reflected in service setting values for the smart service of the smart service server.

Further features of the present disclosure will become apparent from the following description of exemplary embodiments with reference to the attached drawings.

### BRIEF DESCRIPTION OF THE DRAWINGS

FIG. 1 is a diagram illustrating examples of a system configuration and a network configuration according to Example 1.

FIG. 2 is a diagram illustrating an example of a hardware configuration of a contract management server, a contract linkage process execution server, a settings delivery server, and a smart service server according to Example 1.

FIG. 3 is a diagram illustrating an example of a hardware configuration of an image forming apparatus according to Example 1.

FIG. 4 is a diagram illustrating an example of a functional configuration of the contract management server according to Example 1.

FIG. 5 is a diagram illustrating an example of a functional configuration of the contract linkage process execution server according to Example 1.

FIG. 6 is a diagram illustrating an example of a functional configuration of the settings delivery server according to Example 1.

FIG. 7 is a diagram illustrating an example of a functional configuration of the smart service server according to Example 1.

FIG. 8 is a diagram illustrating an example of a functional configuration of the image forming apparatus according to Example 1.

FIG. 9 is a flowchart illustrating an example of a contract linkage process executed by the contract linkage process execution server according to Example 1.

FIG. 10 is a flowchart illustrating an example of a client delivery instruction executing process performed by the contract linkage process execution server according to Example 1.

FIG. 11 is a flowchart illustrating an example of a service delivery configuration executing process executed by the contract linkage process execution server according to Example 1.

FIG. 12 is a sequence diagram illustrating an example of a process according to Example 1.

FIG. 13 is a sequence diagram illustrating an example of the process according to Example 1.

FIG. 14 is a diagram illustrating an example of a user interface displayed on the image forming apparatus according to Example 1.

FIG. 15 is a flowchart illustrating an example of a contract linkage process performed by the contract linkage process execution server according to Example 2.

FIG. 16 is a flowchart illustrating an example of a client delivery instruction executing process performed by the contract linkage process execution server according to Example 2.

FIG. 17 is a flowchart illustrating an example of a service delivery configuration executing process executed by the contract linkage process execution server according to Example 2.

FIG. 18 is a sequence diagram illustrating an example of a process according to Example 3.

FIG. 19 is a sequence diagram illustrating an example of the process according to Example 3.

FIG. 20 is a sequence diagram illustrating an example of the process according to Example 3.

FIG. 21 is a sequence diagram illustrating an example of a process according to Example 4.

FIG. 22 is a sequence diagram illustrating an example of the process according to Example 4.

### DESCRIPTION OF THE EMBODIMENTS

Hereinafter, modes for carrying out the present disclosure will be described with reference to the drawings. An information processing system according to the present embodiment includes a contract management server, a contract linkage process execution server, a settings delivery server, a smart service server, and an image forming apparatus. The smart service server is a server that provides various smart services to the image forming apparatus. According to the present embodiment, the information processing system delivers setting values or the like to both the image forming apparatus and the smart service server in conjunction with a contract.

### Example 1

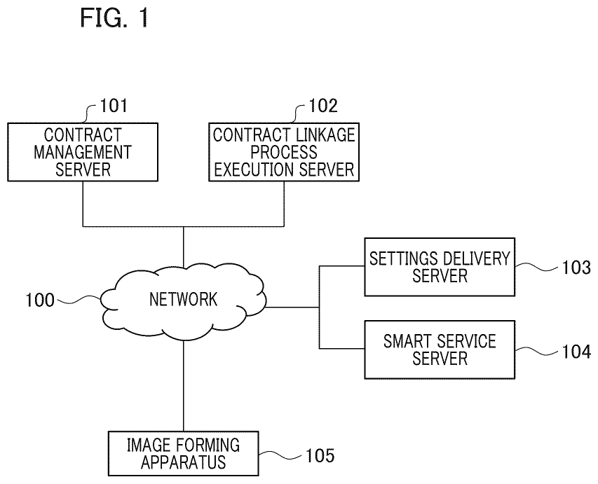

FIG. 1 is a diagram illustrating examples of a system configuration and a network configuration according to Example 1. FIG. 1 illustrates an example of an information processing system according to Example 1. A contract management server 101 manages contract information input by servicemen, customers, and the like. A contract linkage process execution server 102 transmits a delivery instruction to a settings delivery server 103 or a smart service server 104 using start of a contract period managed by the contract management server 101 as a trigger. The detection of the start of the contract period may be executed by the contract management server 101 or may be executed by the contract linkage process execution server 102. The settings delivery server 103 delivers a setting value, firmware, and an application to the image forming apparatus 105. The settings delivery server 103 may execute a process of delivery of the setting values, the firmware, and the application using a delivery instruction from the contract linkage process execution server 102 as a trigger.

The smart service server 104 supplies various smart services available in the image forming apparatus 105. The smart service server 104 has setting values of service users including the image forming apparatus 105. The number of image forming apparatuses 105 different from the number of image forming apparatuses 105 illustrated in FIG. 1 may be connected to the smart service server 104. Accordingly, the smart service server 104 may deliver setting values to the plurality of image forming apparatuses 105. The image forming apparatus 105 executes setting of the setting values, installation of firmware, and installation of applications by communicating with the settings delivery server 103. The number of image forming apparatuses 105 different from the number illustrated in FIG. 1 may be connected.

As illustrated in FIG. 1, the contract management server 101, the contract linkage process execution server 102, the settings delivery server 103, the smart service server 104, and the image forming apparatus 105 are connected to each other via a network 100.

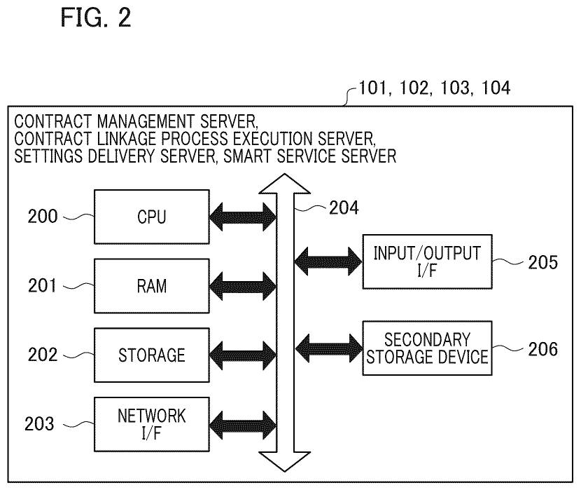

FIG. 2 is a diagram illustrating an example of a hardware configuration of the contract management server, the contract linkage process execution server, the settings delivery server, and the smart service server according to Example 1. A random access memory (RAM) 201 is a temporary memory area. A storage 202 records embedded programs and data. A network interface 203 is connected to the network 100 and executes communication with another computer or a network apparatus. A scheme for the communication may be wired or wireless. The network interface 203 may retain a mobile network interface.

An input/output interface 205 inputs and outputs information or a signal in a display, a keyboard, a mouse, a touch panel, a button, or the like. When a computer that does not have such hardware is mounted, the input/output interface 205 also enables an operation through connection from another computer by a remote desktop, a remote shell, or the like. A secondary storage device 206 is, for example, a hard disk drive (HDD) or a flash memory. A central processing unit (CPU) 200 executes a program read from the RAM 201, the storage 202, the secondary storage device 206, or the like.

As illustrated in FIG. 2, a system bus 204 connects the CPU 200, the RAM 201, the storage 202, the network interface 203, the input/output interface 205, and the secondary storage device 206. In Example 1, unless otherwise mentioned, the system bus 204 is assumed to propagate a control command from the CPU 200 to each piece of hardware connected to the system bus 204.

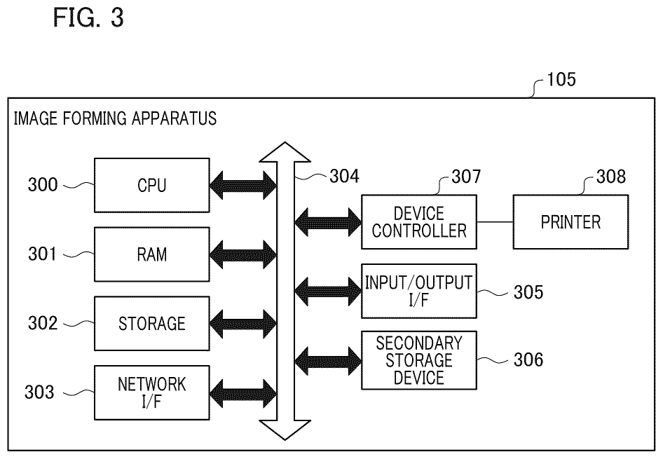

FIG. 3 is a diagram illustrating an example of a hardware configuration of an image forming apparatus according to Example 1. ARAM 301 is a temporary memory area. A storage 302 records an embedded program and data. A network interface 303 is connected to the network 100 and executes communication with another computer or a network apparatus. A scheme for the communication may be wired or wireless. The network interface 303 may retain a mobile network interface.

An input/output interface 305 inputs and outputs information or a signal in a touch panel, a button, or the like. When the image forming apparatus 105 does not have such hardware, the input/output interface 305 also enables an operation through connection from another computer by a remote interface or the like. A secondary storage device 306 is, for example, an HDD or a flash memory. A CPU 300 executes a program read from the RAM 301, the storage 302, the secondary storage device 306, or the like. A printer 308 executes a job such as printing. A device controller 307 controls the printer 308 in response to a control command from the CPU 300.

As illustrated in FIG. 3, a system bus 304 connects the CPU 300, the RAM 301, the storage 302, the network interface 303, the input/output interface 305, and the secondary storage device 306 and the device controller 307. In Example 1, unless otherwise mentioned, the system bus 304 is assumed to propagate a control command from the CPU 300 to each hardware connected to the system bus 304.

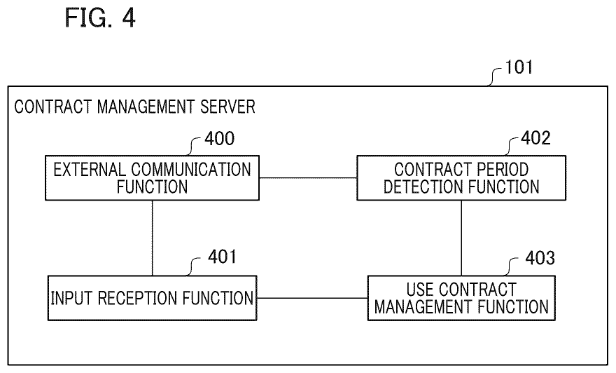

FIG. 4 is a diagram illustrating an example of a functional configuration of the contract management server according to Example 1. As illustrated in FIG. 4, the contract management server 101 has an external communication function 400, an input reception function 401, a contract period detection function 402, and a use contract management function 403. These functions are realized by causing the CPU 200 to read and execute a program stored in the RAM 201, the storage 202, the secondary storage device 206, or the like. The contract management server 101 executes access to the outside such as the contract linkage process execution server 102 by the network interface 203.

The contract management server 101 receives contract information registered by a user such as a serviceman or a customer by the external communication function 400. The external communication function 400 realizes communication with the outside of the contract management server 101. A method of registering the contract information is, for example, an application programming interface (API), transmission of a message or an electronic mail, or an input of contract information by a remote desktop. The input reception function 401 determines contract information received by the external communication function 400. The use contract management function 403 manages use contract of a smart service. The use contract management function 403 retains the contract information determined by the input reception function 401. The contract management server 101 may acquire contract information by the contract period detection function 402 started using a timer or the like as a trigger and detect start of a contract. Here, the contract management server 101 may not have the contract period detection function 402 when there is the contract period detection function outside of the contract management server 101, such as the contract linkage process execution server 102. The contract period detection function 402 detects a period of the use contract. The contract information is, for example, information such as the following Instance 1.

### Instance 1. Contract Information

```
{
  “ContractId”: “CNT00001”,
  “CustomerId”: “CST00001”,
  “DistributorId”: “DST00001”,
  “ContainedSmartServices”: [
    “Data Backup Service”,
    “Auto Delivery Service”,
    “Lifetime Predict Service”
  ],
  “CustomerAgreement”: {
    “Data Backup Service”: “True”,
    “Auto Delivery Service”: “True”,
    “Lifetime Predict Service”: “True”
  },
  “StartDate”: “2023/11/1 00:00:00”,
  “EndDate”: “2025/12/31 23:59:59”,
  “CreatedDate”: “2023/9/10 12:00:00”,
}
```

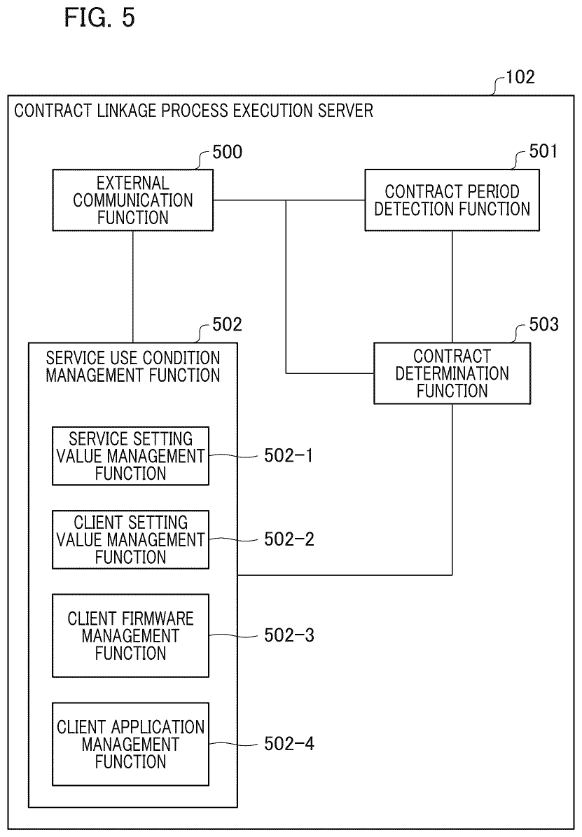

FIG. 5 is a diagram illustrating an example of a functional configuration of the contract linkage process execution server according to Example 1. As illustrated in FIG. 5, the contract linkage process execution server 102 has an external communication function 500, a contract period detection function 501, a service use condition management function 502, and a contract determination function 503. These functions are realized by causing the CPU 200 to read and execute a program stored in the RAM 201, the storage 202, the secondary storage device 206, or the like. The contract linkage process execution server 102 executes access to the outside such as the contract management server 101, the settings delivery server 103, or smart service server 104 by the network interface 203.

The contract linkage process execution server 102 acquires the contract information from the contract management server 101 via the external communication function 500 by the contract period detection function 501. The contract period detection function 501 detects a period of the use contract. For example, the contract period detection function 501 determines whether the period of the use contract has started or the use contract has been updated. More specifically, the contract period detection function 501 determines whether the contract period has started from the acquired contract information. When the contract period detection function is outside of the contract management server 101 or the like or contract start information is received via the external communication function 500, the contract linkage process execution server 102 may not have the contract period detection function 501. Here, the contract linkage process execution server 102 determines the smart service information related to the contract information of which the contract period has started, that is, the smart service information to be started by the contract determination function 503. The contract determination function 503 executes a process necessary to execute determination related to the use contract managed by the use contract management function 403. For example, the contract determination function 503 inquires about each piece of smart service information to be started of the service use condition management function 502.

The service use condition management function 502 manages a use condition of a smart service. As illustrated in FIG. 2, the service use condition management function 502 includes a service setting value management function 502-1, a client setting value management function 502-2, a client firmware management function 502-3, and a client application management function 502-4.

The service setting value management function 502-1 retains service request settings information required to be set on a service side to start using each smart service.

The service request settings information is, for example, information such as the following Instance 2.

### Instance 2. Service Request Settings Information

```
  {
    “SmartServiceId”: “SRV00001”,
    “SmartServiceName”: “Data Backup Service”,
    “IsEnable”: “True”,
    “Type”: “ClientSettingInfo.BackupSettings.Type”,
    “ApplicationBackup”:
“ClientSettingInfo.BackupSettings.ApplicationBackup”,
    “WeeklyBackup”:
    “ClientSettingInfo.BackupSettings.WeeklyBackup”,
  “WeeklySettings”: {
      “Day”: “Random(Sunday, Wednesday, Friday)”,
      “Time”: “Random(0:00, 1:00, 2:00)”
    },
  “AlartSettings”: {
      “SendServiceAlart”: “True”,
      “AlartType”: [
        “AlartType”: “WeeklyBackupIsNotDone”
      ]
    }
  }
```

The client setting value management function 502-2 retains the client request settings information required to be set in the image forming apparatus 105 that is a client to start using each smart service. The client request settings information is, for example, information such as the following Instance 3.

### Instance 3. Client Request Settings Information

```
{
  “SmartServiceId”: “SRV00001”,
  “SmartServiceName”: “Data Backup Service”,
  “AccessToken”: “ON”
  “BackupSettings”: {
    “Type”: “Differencial”,
    “ApplicationBackup”: “ON”
    “WeeklyBackup”: “ON”,
    “WeeklySettings”: {
      “Day”: “ServiceSettingInfo.WeeklySettings.Day”,
    “Time”: “ServiceSettingInfo.WeeklySettings.Time”
    }
  }
}
```

The client firmware management function 502-3 retains firmware request information required to be installed in the image forming apparatus 105 to start using each smart service. The firmware request information is, for example, information such as the following Instance 4.

### Instance 4. Firmware Request Information

```
{
  “SmartServiceId”: “SRV00001”,
  “SmartServiceName”: “Data Backup Service”,
  “RequiredFirmware”: {
    “Name”: “SmartServiceFirmware”,
    “Version”: “3.0.0”,
    “Comparison”: “Greater Than”
  }
}
```

The client application management function 502-4 retains application request information required to be installed in the image forming apparatus 105 to start using each smart service. The application request information is, for example, information such as the following Instance 5.

### Instance 5. Application Request Information

```
{
  “SmartServiceId”: “SRV00001”,
  “SmartServiceName”: “Data Backup Service”,
  “RequiredApplications”: [
    {
      “Name”: “Service Accessor”,
      “Version”: “4.1.0”,
      “Comparison”: “Equals”
    },
    {
      “Name”: “Backup Service Client”,
      “Version”: “1.0.0”,
      “Comparison”: “Greater Than”
    }
  ]
}
```

The contract determination function 503 receives various use conditions of each smart service that has started to be used as a response to the inquiry from the service use condition management function 502. The various use conditions include the service request settings information, the client request settings information, the firmware request information, and the application request information described above.

The contract determination function 503 generates a service delivery instruction based on the above-described service request settings information. Accordingly, next, an example of the service delivery instruction generation process executed by the contract determination function 503 will be described. The contract determination function 503 uses designated values as fixed setting values in the above-described service request settings information as they are. When the above-described service request settings information has a value starting from “ClientSettingInfo.,” the contract determination function 503 uses values set for the same name key of the above-described client request settings information. When the above-described service request settings information has a value enclosed by “Random( . . . ),” the contract determination function 503 randomly selects and uses one of listed values. For example, to reduce load on the server, the random selection can be used in order to distribute execution dates and times at which weekly backup is executed.

The contract determination function 503 transmits a service delivery instruction based on the use conditions. For example, the contract determination function 503 transmits a service delivery instruction related to settings for using the smart service of the image forming apparatus 105 in the smart service server 104 to the smart service server 104 via the external communication function 500. The contract determination function 503 executes the transmission upon determining that the period of the use contract has started or the use contract has been updated. Further, the contract determination function 503 executes the transmission of the service delivery instruction when a service request setting for a smart service is included as a use condition of the smart service. Conversely, when the service request setting for the smart service is not included as the use condition of the smart service, the contract determination function 503 does not execute the transmission of the service delivery instruction. The contract determination function 503 may transmit the service delivery instruction to the plurality of smart service servers 104. The service delivery information is, for example, information such as the following Instance 6.

### Instance 6. Service Delivery Instruction

```
{
  “ServiceSettings”: {
      “CustomerAgreement”: {
            “Data Backup Service”: “True”
        },
        “IsEnable”: “True”,
        “Type”: “Differencial”,
        “ApplicationBackup”: “ON”
        “WeeklyBackup”: “ON”,
        “WeeklySettings”: {
              “Day”: “Wednesday”,
              “Time”: “2:00”
          },
          “AlartSettings”: {
            “SendServiceAlart”: “True”,
            “AlartType”: [
                “AlartType”: “WeeklyBackupIsNotDone”
            ]
          }
    }
}
```

The contract determination function 503 generates a client delivery instruction based on the above-described client request settings information. Accordingly, next, an example of the client delivery instruction generation process by the contract determination function 503 will be described. The contract determination function 503 uses designated values as fixed setting values in the client request settings information as they are. When the above-described client request settings information has a value starting from “ServiceSettingInfo.,” the contract determination function 503 uses values set for the same name key of the above-described service request settings information.

The contract determination function 503 updates the client delivery instruction based on the above-described firmware request information. The contract determination function 503 updates the client delivery instruction based on the above-described application request information.

The contract determination function 503 transmits the client delivery instruction based on the use conditions. For example, the contract determination function 503 transmits the client delivery instruction for the process of setting the image forming apparatus 105 to the settings delivery server 103 via the external communication function 500. The contract determination function 503 executes the transmission upon determining that the period of the use contract has started or the use contract has been updated. The contract determination function 503 may transmit the client delivery instruction to the plurality of image forming apparatuses 105. The client delivery information is, for example, information such as the following Instance 7.

### Instance 7. Client Delivery Instruction

```
{
  “ClientSettings”: {
      “AccessToken”: “ON”
      “CustomerAgreement”: {
            “Data Backup Service”: “True”
        },
        “BackupSettings”: {
            “Type”: “Differencial”,
            “ApplicationBackup”: “ON”
            “WeeklyBackup”: “ON”,
            “WeeklySettings”: {
                “Day”: “Wednesday”,
                “Time”: “2:00”
            }
        },
    “ClientFirmware”: {
          “Name”: “SmartServiceFirmware”,
          “Version”: “3.0.0”,
          “Comparison”: “Greater Than”
      },
        “ClientApplications”: [
              “Name”: “Service Accessor”,
              “Version”: “4.1.0”,
              “Comparison”: “Equals”
          },
          {
                  “Name”: “Backup Service Client”,
                  “Version”: “1.0.0”,
                  “Comparison”: “Greater Than”
            }
      ]
]
```

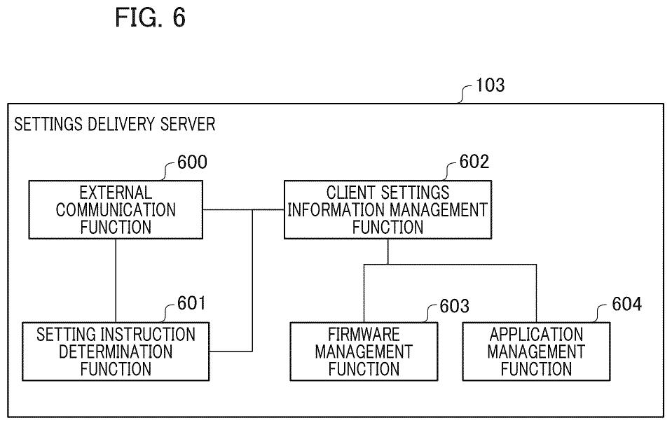

FIG. 6 is a diagram illustrating an example of a functional configuration of the settings delivery server according to Example 1. As illustrated in FIG. 6, the settings delivery server 103 has an external communication function 600, a setting instruction determination function 601, a client settings information management function 602, a firmware management function 603, and an application management function 604. These functions are realized by causing the CPU 200 to read and execute a program stored in the RAM 201, the storage 202, the secondary storage device 206, or the like. The settings delivery server 103 executes access to the outside such as the contract linkage process execution server 102, the image forming apparatus 105, or the like by the network interface 203.

The settings delivery server 103 receives a client delivery instruction from the contract linkage process execution server 102. The setting instruction determination function 601 determines the received client delivery instruction. The client settings information management function 602 manages the settings information of the image forming apparatus 105. For example, the client settings information management function 602 generates the client delivery information based on the above-described client delivery instruction. The client delivery information includes the client settings information, the client firmware information, and the client application information described above. The client settings information management function 602 transmits the generated client delivery information to the image forming apparatus 105 by the external communication function 600.

The settings delivery server 103 manages a firmware file by the firmware management function 603 and manages an application file by the application management function 604. The firmware management function 603 and the application management function 604 can issue a uniform resource locator (URL) of each file. The image forming apparatus 105 can receive the firmware file and the application file by accessing the URL. The client settings information management function 602 can include the URL in the client delivery information. The client delivery information is, for example, information such as the following Instance 8.

### Instance 8. Client Delivery Information

```
{
  “ClientSettings”: {
      “Access Token”: “ON”
      “CustomerAgreement”: {
          “Data Backup Service”: “True”
      },
      “BackupSettings”: {
      “Type”: “Differencial”,
      “ApplicationBackup”: “ON”
      “WeeklyBackup”: “ON”,
      “WeeklySettings”: {
          “Day”: “Wednesday”,
          “Time”: “2:00”
      }
    },
  “ClientFirmware”: {
      “Name”: “SmartServiceFirmware”,
      “Version”: “3.3.0”,
      “Path”: “ProvServer/firm/smartservicefirm/v3/”,
      “FileName”: “SmartServiceFirmware_3.3.0.zip”,
      “URL”: “https://ProvServer/firm/smartservicefirm/3.3.0”
    },
    “ClientApplications”: [
        {
            “Name”: “Service Accessor”,
            “Version”: “4.1.0”,
            “Path”: “ProvServer/app/serviceaccessor/v4/”,
            “FileName”: “Service Accessor_4.1.0.zip”,
            “URL”: “https://ProvServer/app/serviceaccessor/4.1.0”
          },
          {
              “Name”: “Backup Service Client”,
              “Version”: “2.4.0”,
              “Path”: “ProvServer/app/backupserviceclient/v2/”,
            “FileName”: “Backup Service Client_2.4.0.zip”,
            “URL”: “https://ProvServer/app/ backupserviceclient/2.4.0”
          }
    ]
}
```

The client settings information management function 602 may generate the client delivery information through a UI operation by a user via an input/output interface of the settings delivery server 103, a remote desktop, or the like. The client settings information management function 602 may receive a setting delivery request, a firmware installation request, an application installation request, or the like from the image forming apparatus 105 and generate the client delivery information.

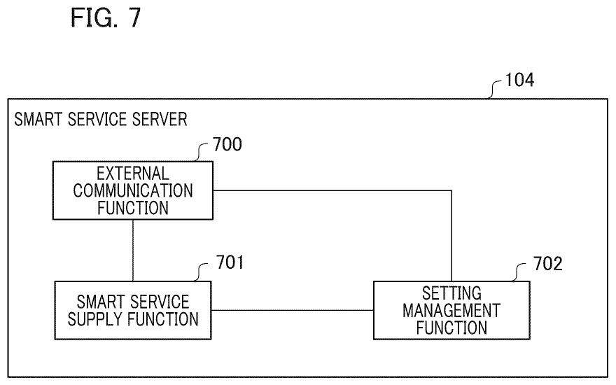

FIG. 7 is a diagram illustrating an example of a functional configuration of the smart service server according to Example 1. As illustrated in FIG. 7, the smart service server 104 includes an external communication function 700, a smart service supply function 701, and a setting management function 702. These functions are realized by causing the CPU 200 to read and execute a program stored in the RAM 201, the storage 202, the secondary storage device 206, or the like. The smart service server 104 executes access to the outside such as the contract linkage process execution server 102 by the network interface 203.

The smart service server 104 receives a service delivery instruction from the contract linkage process execution server 102 via the external communication function 700. The setting management function 702 can reflect the received service delivery instruction in the service setting values and retain the received service delivery instruction.

The smart service supply function 701 differs depending on a service to be supplied. A case in which the smart service supply function 701 supplies a data backup service will be given as an example. The smart service supply function 701 receives and retains backup data from the image forming apparatus 105. The smart service supply function 701 receives a restoration instruction and reflects the backup data. In Example 1, there is no influence in accordance with a type of smart service function. Therefore, generalization of the smart service function as the smart service supply function 701 will be described. The smart service supply function 701 can refer to a service setting values retained in the setting management function 702.

As an example of a combination of a smart service and a setting value type retained by the setting management function 702, for example, a data backup service and a periodic backup setting including an ON/OFF setting, a period setting, and a weekday setting can be exemplified. Alternatively, as an example of the combination, a data backup service and a backup format setting for selecting complete backup or differential backup are exemplified. Alternatively, as an example of the combination, a part lifetime prediction service and a unit-by-unit notification ON/OFF setting or an alert notification reference setting can be exemplified. Alternatively, as an example of the combination, a consumable prediction delivery service and an automatic delivery ON/OFF setting, a delivery reference setting, or a payment method setting can be exemplified. Alternatively, as an example of the combination, an external cloud service document backup and an automatic backup setting or deletion setting can be exemplified. The setting value retained by the setting management function 702 is, for example, a setting value such as the following Instance 9.

### Instance 9. Service Setting Value

```
{
  “ServiceEnabled”: “True”,
  “WeeklyBackup”: “ON”,
  “WeeklyBackupSettings”: {
      “Day”: “Wednesday”,
      “Time”: “2:00”
    },
  “AlartSettings”: {
    “SendServiceAlart”: “True”,
    “AlartType”: [
        “AlartType”: “WeeklyBackupIsNotDone”
    ]
  },
  “CustomerAgreement”: {
      “Data Backup Service”: “True”
  }
}
```

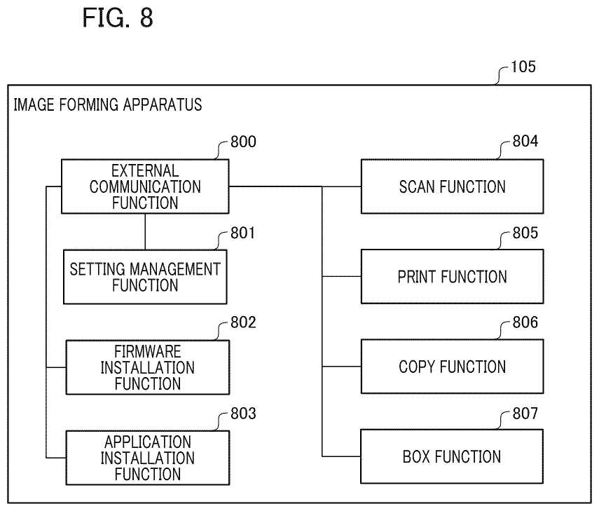

FIG. 8 is a diagram illustrating an example of a functional configuration of the image forming apparatus according to Example 1. As illustrated in FIG. 8, the image forming apparatus 105 has an external communication function 800, a setting management function 801, a firmware installation function 802, and an application installation function 803. As illustrated in FIG. 8, the image forming apparatus 105 has a scan function 804, a print function 805, a copy function 806, and a box function 807. These functions are realized by causing the CPU 300 to read and execute a program stored in the RAM 301, the storage 302, the secondary storage device 306, or the like. The image forming apparatus 105 executes access to the outside such as the settings delivery server 103 by the network interface 203.

The image forming apparatus 105 receives the client delivery information from the settings delivery server 103 via the external communication function 800. The setting management function 801 reflects the client settings information included in the received client delivery information in the client setting value and retains the client settings information. The firmware installation function 802 executes firmware installation based on firmware information included in the received client delivery information.

The application installation function 803 executes application installation based on application information included in the received client delivery information. The setting value retained by the setting management function 801 is, for example, a setting value such as the following Instance 10.

### Instance 10. Client Setting Value

```
{
  “DistributorType”: “Normal”,
  “ServiceMode”: “False”,
  “BackupEnabled”: “True”,
  “WeeklyBackup”: “ON”,
  “WeeklyBackupSettings”: {
      “Day”: “Wednesday”,
      “Time”: “2:00”
  },
  “AccessToken”: “ON”
  “BackupSettings”: {
      “Type”: “Differencial”,
      “ApplicationBackup”: “ON”
      “WeeklyBackup”: “ON”,
      “WeeklySettings”: {
          “Day”: “Wednesday”,
          “Time”: “2:00”
      }
    },
    “CustomerAgreement”: {
        “Data Backup Service”: “True”
    }
}
```

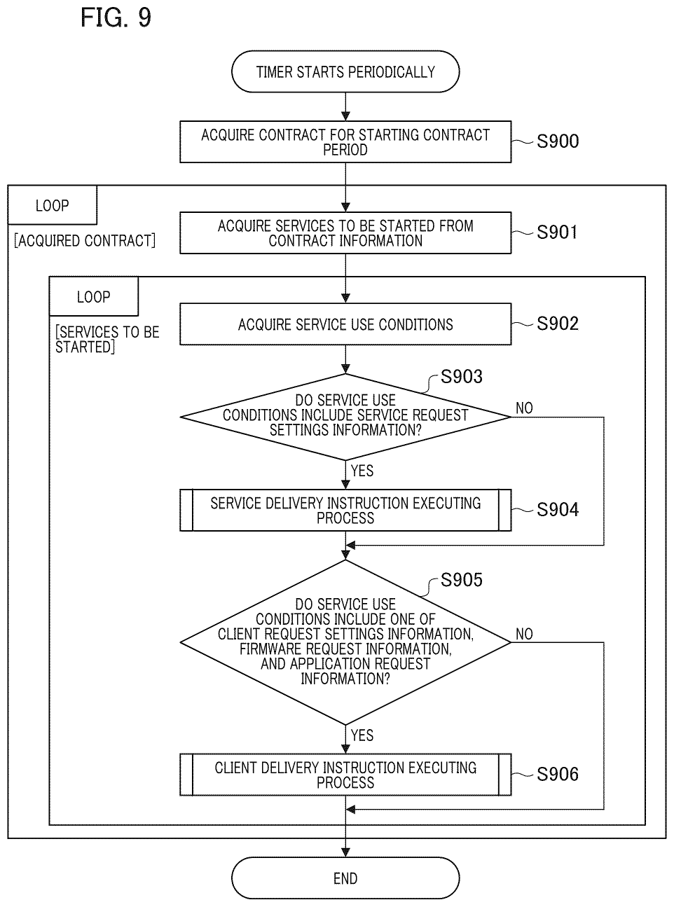

FIG. 9 is a flowchart illustrating an example of a contract linkage process executed by the contract linkage process execution server according to Example 1. A contract linkage process execution flow illustrated in FIG. 9 has started by a trigger activated in a regular period.

In step S900, the contract determination function 503 acquires a contract of which a contract period has started from the contract management server 101. The contract of which start of the contract period has started indicates a contract of which a contract period from start of a previous process to start of a current process has passed. The following process is executed in a loop for all contracts of which contract periods start.

In step S901, the contract determination function 503 acquires a smart service list to be started from target contract information. The following process is executed in a loop for all smart services to be started.

In step S902, the contract determination function 503 acquires service use conditions of the smart services to be started from the service use condition management function 502.

In step S903, the contract determination function 503 determines whether the service use conditions of the smart services to be started include the service request settings information. When the contract determination function 503 determines that the service use conditions of the smart services to be started include the service request settings information, the process proceeds to step S904. Conversely, when the contract determination function 503 determines that the service use conditions of the smart services to be started do not include the service request settings information, the process proceeds to step S905.

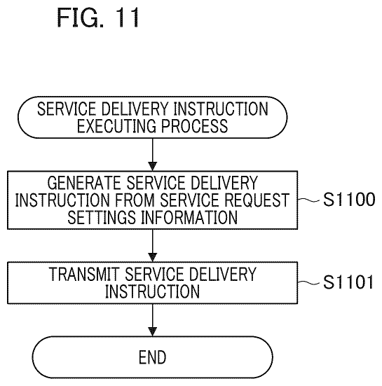

In step S904, the contract determination function 503 executes a service delivery instruction executing process. The details of the service delivery instruction executing process will be described with reference to FIG. 11.

In step S905, the contract determination function 503 determines whether the service use conditions of the smart services to be started include the client request settings information, the firmware request information, or the application request information. When the contract determination function 503 determines that the service use conditions of the smart services to be started include at least one of the pieces of information, the process proceeds to step S906. Conversely, when the contract determination function 503 determines that the the service use conditions of the smart services to be started does not include the information, the process ends.

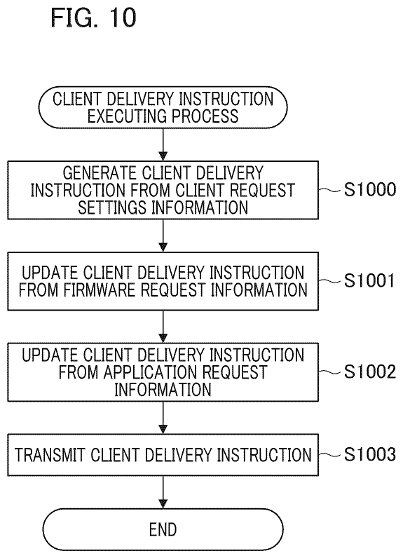

In step S906, the contract determination function 503 executes a client delivery instruction executing process. The details of the client delivery instruction executing process will be described with reference to FIG. 10.

FIG. 10 is a flowchart illustrating an example of a client delivery instruction executing process performed by the contract linkage process execution server according to Example 1.

In step S1000, the contract determination function 503 generates a client delivery instruction based on the client request settings information acquired from the client setting value management function 502-2.

In step S1001, the contract determination function 503 updates the client delivery instruction based on the firmware request information acquired from the client firmware management function 502-3.

In step S1002, the contract determination function 503 updates the client delivery instruction based on the application request information acquired from the client application management function 502-4.

In step S1003, the contract determination function 503 transmits the client delivery instruction to the settings delivery server 103 via the external communication function 500.

FIG. 11 is a flowchart illustrating an example of a service delivery instruction executing process executed by the contract linkage process execution server according to Example 1.

In step S1100, the contract determination function 503 generates the service delivery instruction based on the service request settings information acquired from the service setting value management function 502-1.

In step S1101, the contract determination function 503 transmits the generated service delivery instruction to the smart service server 104 via the external communication function 500.

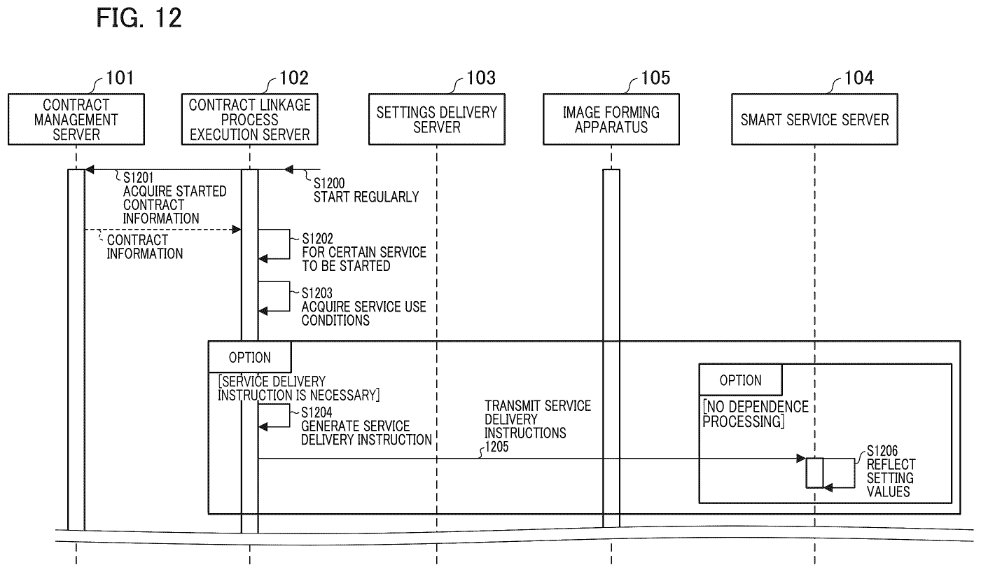

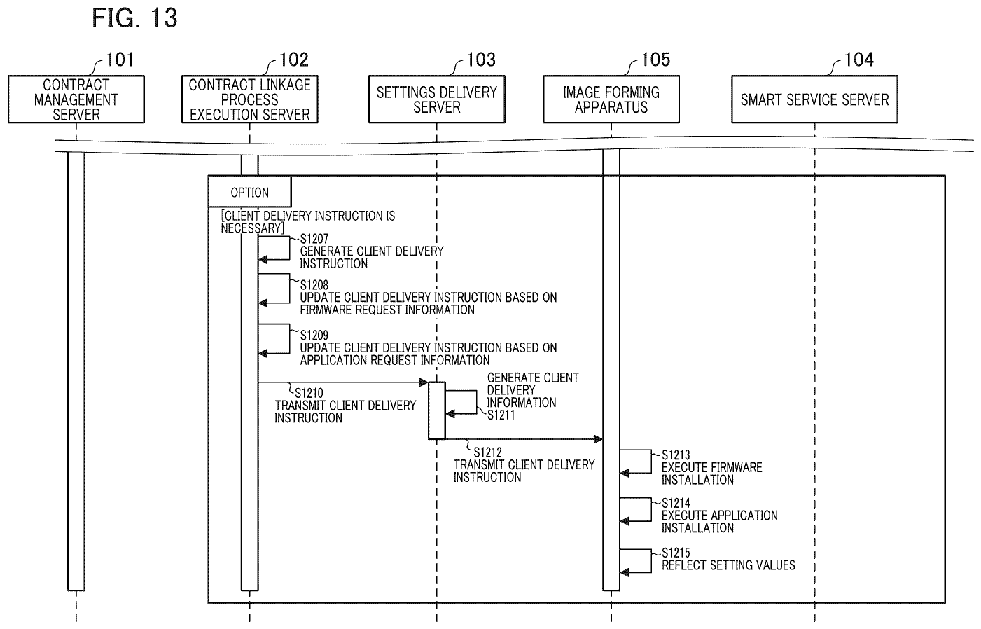

FIGS. 12 and 13 are sequence diagrams illustrating an example of a process according to Example 1.

In step S1200, the contract linkage process execution server 102 has started periodically by a trigger started for each regular period.

In step S1201, the contract linkage process execution server 102 acquires a contract of which a contract period has started from the contract management server 101 by the contract determination function 503. The contract linkage process execution server 102 determines whether the contract period has started by the contract period detection function 501. A loop process is executed from the contract acquired here and a smart service included in the contract, but is omitted in FIG. 12 for simplification.

In step S1202, the contract linkage process execution server 102 represents a process for a specific smart service in the loop.

In step S1203, the contract linkage process execution server 102 acquires the service use conditions of the smart service from the service use condition management function 502 by the contract determination function 503.

In step S1204, the contract linkage process execution server 102 generates a service delivery instruction based on the service request settings information by the contract determination function 503 when the use conditions of the target smart service include the service request settings information.

In step S1205, the contract linkage process execution server 102 transmits the generated service delivery instruction to the smart service server 104 by the contract determination function 503.

In step S1206, the smart service server 104 reflects and retains the service setting values by the setting management function 702 in response to the received service delivery instruction.

In step S1207, when the use conditions of the target smart service include the client request settings information, the contract linkage process execution server 102 generates the client delivery instruction based on the client request settings information by the contract determination function 503.

In step S1208, when the use conditions of the target smart service include the firmware request information, the contract linkage process execution server 102 updates the client delivery instruction based on the firmware request information by the contract determination function 503.

In step S1209, when the use conditions of the target smart service include the application request information, the contract linkage process execution server 102 updates the client delivery instruction based on the application request information by the contract determination function 503.

In step S1210, the contract linkage process execution server 102 transmits the generated client delivery instruction to the settings delivery server 103.

In step S1211, the settings delivery server 103 generates the client delivery information based on the client delivery instruction by the setting instruction determination function 601.

In step S1212, the settings delivery server 103 transmits the generated client delivery instruction to the image forming apparatus 105.

In step S1213, the image forming apparatus 105 executes firmware installation in accordance with the client delivery information by the firmware installation function 802.

The image forming apparatus 105 executes application installation in accordance with the client delivery information by the application installation function 803.

In step S1215, the image forming apparatus 105 reflects and retains the client setting values by the setting management function 801 in accordance with the client delivery information.

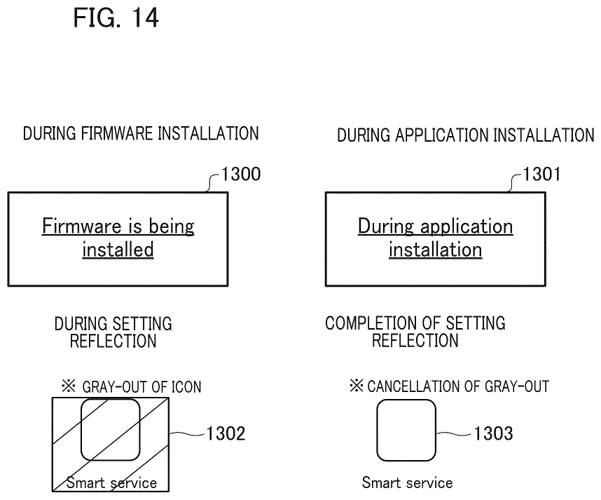

FIG. 14 is a diagram illustrating an example of a user interface displayed on the image forming apparatus according to Example 1. A user interface illustrated in FIG. 14 is displayed when a contract linkage process is executed on the contract linkage process execution server 102 and the client delivery information is received by the image forming apparatus 105 via the settings delivery server 103 in association with the start of the contract.

The image forming apparatus 105 displays a message 1300 indicating that the firmware is being installed on a screen while the firmware installation is being executed in association with the start of the contract. The image forming apparatus 105 displays a message 1301 indicating that the application is being installed on the screen while the application installation is being executed in association with the start of the contract.

The image forming apparatus 105 displays a grayed-out application icon 1302 for the target smart service while a process of reflecting the setting values in the image forming apparatus 105 is being executed after completion of the application installation. Alternatively, the image forming apparatus 105 displays the grayed-out application icon 1302 for the target smart service while a process of reflecting the setting values in the smart service server 104 is being executed after the completion of the application installation.

The image forming apparatus 105 displays an application icon 1303 of which gray-out is cancelled for a target smart service after the process of reflecting the setting value in the image forming apparatus 105 and the process of reflecting the setting value in the smart service server 104 are completed.

### Example 2

In description of Example 2, only differences from Example 1 will be described. In Example 2, setting values or the like delivered in association with start of a contract can be set according to a desire of a customer. In Example 2, apart from various use conditions (Instances 2 to 5) retained by the service use condition management function 502 in the contract linkage process execution server 102 in Example 1, the contract management server 101 retains customer setting value information by the use contract management function 403. When a contract linkage process is executed by the contract determination function 503, the contract linkage process execution server 102 uses the customer setting value information preferentially. When the contract linkage process is executed by the contract determination function 503, the contract linkage process execution server 102 generates a delivery instruction by using various use conditions retained by the service use condition management function 502 with regard to an item that is not present in the customer setting value information.

In Example 2, the contract information retained by the use contract management function 403 illustrated in FIG. 4 includes customer setting values. The customer setting values are setting values reflected when use of a smart service has started. The contract information according to Example 2 is, for example, information such as the following Instance 11.

### Instance 11. Contract Information in Example 2

```
{
  “ContractId”: “CNT00002”,
  “CustomerId”: “CST00002”,
  “DistributorId”: “DST00002”,
  “ContainedSmartServices”: [
        “Data Backup Service”
  ],
  “CustomerAgreement”: {
        “Data Backup Service”: “True”,
  },
  “StartDate”: “2023/11/1 00:00:00”,
  “EndDate”: “2025/12/31 23:59:59”,
  “CreatedDate”: “2023/9/10 12:00:00”,
  “ClientSettings”: {
        “BackupSettings”: {
        “Type”: “Full”,
        “ApplicationBackup”: “OFF”
        “WeeklyBackup”: “ON”,
        “WeeklySettings”: {
              “Day”: “Sunday”,
              “Time”: “23:00”
          }
      }
  },
  “ServiceSettings”: {
  “WeeklyBackup”: “ON”,
        “WeeklySettings”: {
        “Day”: “Sunday”,
        “Time”: “23:00”
    },
    “AlartSettings
            “SendServiceAlart”: “False”,
            “AlartType”: [ ]
    }
  }
}
```

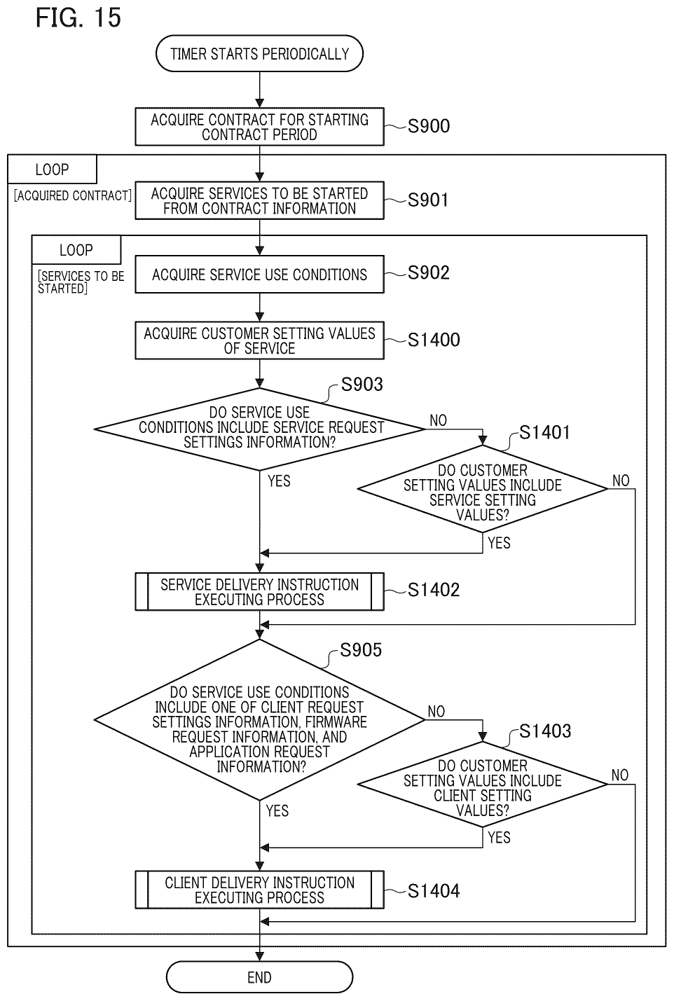

FIG. 15 is a flowchart illustrating an example of a contract linkage process performed by the contract linkage process execution server according to Example 2. A contract linkage process execution flow illustrated in FIG. 15 has started by a trigger activated in a regular period.

In step S900, the contract linkage process execution server 102 acquires a contract of which a contract period has started from the contract management server 101 by the contract determination function 503. Here, the contract of which the contract period has started indicates a contract of which start of a contract period from start of a previous process to start of a current process has passed. A process to be described below is executed in a loop for all contracts of which contract periods start.

In step S901, the contract linkage process execution server 102 acquires a smart service list to be started from target contract information by the contract determination function 503. A process to be described below is executed in a loop for all target smart services to be started.

In step S902, the contract linkage process execution server 102 acquires use conditions of the target smart services by the service use condition management function 502.

In step S1400, the contract linkage process execution server 102 acquires the customer setting values of the target smart service from the acquired contract information by the contract determination function 503.

In step S903, the contract linkage process execution server 102 determines whether the use conditions of the target smart service include the service request settings information by the contract determination function 503. When the contract linkage process execution server 102 determines that the use conditions of the target smart service include the service request settings information by the contract determination function 503, the process proceeds to step S1402. Conversely, when the contract linkage process execution server 102 determines that the use conditions of the target smart service does not include the service request settings information by the contract determination function 503, the process proceeds to step S1401.

In step S1401, the contract linkage process execution server 102 determines whether the customer setting values include the service setting values by the contract determination function 503. When the contract linkage process execution server 102 determines that the customer setting values include the service setting values by the contract determination function 503, the process proceeds to step S1402. Conversely, when the contract linkage process execution server 102 determines that the customer setting values do not include the service setting values by the contract determination function 503, the process proceeds to step S905.

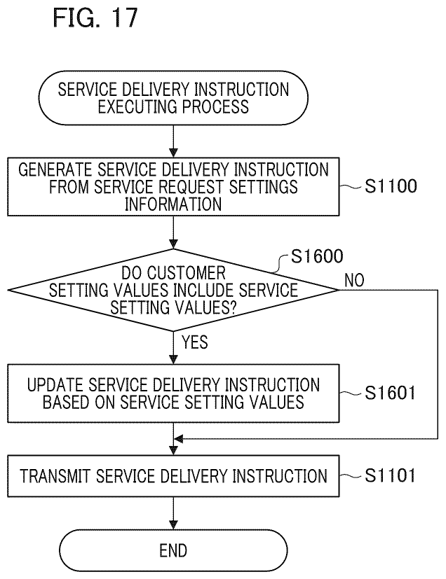

In step S1402, the contract linkage process execution server 102 executes a service delivery instruction executing process. The details of the service delivery instruction executing process in Example 2 will be described with reference to FIG. 17.

In step S905, the contract linkage process execution server 102 determines whether the service use conditions include one of the client request settings information, the firmware request information, and the application request information by the contract determination function 503. When the contract linkage process execution server 102 determines that the service use conditions include one of the three pieces of information, the process proceeds to step S1404. Conversely, when the contract linkage process execution server 102 determines that the service use conditions do not include any of the three pieces of information, the process proceeds to step S1403.

In step S1403, the contract linkage process execution server 102 determines whether the customer setting values include client setting values by the contract determination function 503. When the contract linkage process execution server 102 determines that the customer setting values include client setting values by the contract determination function 503, the process proceeds to step S1404. Conversely, when the contract linkage process execution server 102 determines that the customer setting values do not include client setting values by the contract determination function 503, the process ends.

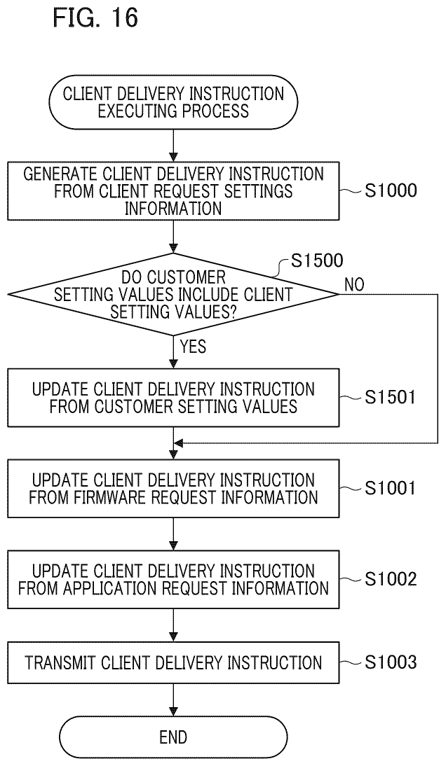

In step S1404, the contract linkage process execution server 102 executes a client delivery instruction executing process. The details of the client delivery instruction executing process in Example 2 will be described with reference to FIG. 16.

FIG. 16 is a flowchart illustrating an example of a client delivery instruction executing process performed by the contract linkage process execution server according to Example 2. The client delivery instruction executing process is a process executed in the above-described step S1404.

In step S1000, the contract linkage process execution server 102 generates a client delivery instruction based on the client request settings information acquired from the client setting value management function 502-2 contained in the service use condition management function 502 by the contract determination function 503.

In step S1500, the contract linkage process execution server 102 determines whether the customer setting values include the client setting values by the contract determination function 503. When the contract linkage process execution server 102 determines that the customer setting values include the client setting values by the contract determination function 503, the process proceeds to step S1501. Conversely, when the contract linkage process execution server 102 determines that the customer setting values do not include the client setting values by the contract determination function 503, the process proceeds to step S1001.

In step S1501, the contract linkage process execution server 102 updates the client delivery instruction based on the customer setting values by the contract determination function 503.

In step S1001, the contract linkage process execution server 102 updates the client delivery instruction based on the firmware request information acquired from the client firmware management function 502-3 contained in the service use condition management function 502 by the contract determination function 503.

In step S1002, the contract linkage process execution server 102 updates the client delivery instruction based on the application request information acquired from the client application management function 502-4 contained in the service use condition management function 502 by the contract determination function 503.

In step S1003, the contract linkage process execution server 102 transmits the above-described client delivery instruction to the settings delivery server 103 via the external communication function 500 by the contract determination function 503.

FIG. 17 is a flowchart illustrating an example of a service delivery instruction executing process executed by the contract linkage process execution server according to Example 2. The service delivery instruction executing process is a process executed in the above-described step S1402.

In step S1100, the contract linkage process execution server 102 generates the service delivery instruction based on the service request settings information acquired from the service setting value management function 502-1 contained in the service use condition management function 502 by the contract determination function 503.

In step S1600, the contract linkage process execution server 102 determines whether the customer setting values include the service setting values by the contract determination function 503. When the contract linkage process execution server 102 determines that the customer setting values include the service setting values by the contract determination function 503, the process proceeds to step S1601. Conversely, when the contract linkage process execution server 102 determines that the customer setting values do not include the service setting values by the contract determination function 503, the process proceeds to step S1101.

In step S1601, the contract linkage process execution server 102 updates the service delivery instruction based on the service setting values by the contract determination function 503.

In step S1101, the contract linkage process execution server 102 transmits the generated service delivery instruction to the smart service server 104 via the external communication function 500 by the contract determination function 503.

### Example 3

In description of Example 3, only differences from Example 1 will be described. In Example 3, an order of execution of a service delivery instruction in the smart service server 104 and execution of a client delivery instruction in the image forming apparatus 105 can be controlled. This control is referred to as order control. In Example 3, the smart service server 104 executes a process conforming with the service delivery instruction under the order control. In Example 3, the image forming apparatus 105 executes client setting value delivery, firmware installation, and application installation in conformity with the client delivery instruction under the order control.

In Example 3, dependence processing information is stored in the various use conditions described in Instances 2 and 5. The dependence processing information is information indicating setting value reflection, firmware installation, or application installation required to end in order to execute the process. The dependence processing information may be retained as identification information (process ID) assigned to each process. The dependence processing information may be retained as setting values set actually and a firmware name or an application name to be installed. The service request settings information depending on some of the client firmware is, for example, information such as the following Instance 12. In Instance 12, a dependsOn attribute indicates the dependence processing information.

### Instance 12. Service Request Settings Information in Example 3

```
  {
    “SmartServiceId”: “SRV00001”,
    “SmartServiceName”: “Data Backup Service”,
    “IsEnable”: “True”,
    “Type”: “ClientSettingInfo.BackupSettings.Type”,
    “ApplicationBackup”:
“ClientSettingInfo.BackupSettings.ApplicationBackup”,
    “WeeklyBackup”:
    “ClientSettingInfo.BackupSettings.WeeklyBackup”,
    “WeeklySettings”: {
        “Day”: “Random(Sunday, Wednesday, Friday)”,
        “Time”: “Random(0:00, 1:00, 2:00)”
      },
      “AlartSettings”: {
          “SendServiceAlart”: “True”,
          “AlartType”: [
              “AlartType”: “WeeklyBackupIsNotDone”
      ]
    },
    “dependsOn”: [
        {
            “ClientFirmware”: {
                “Name”: “SmartServiceFirmware”,
                “Version”: “3.0.0”,
                “Comparison”: “Greater Than”
            }
      }
    ]
  }
```

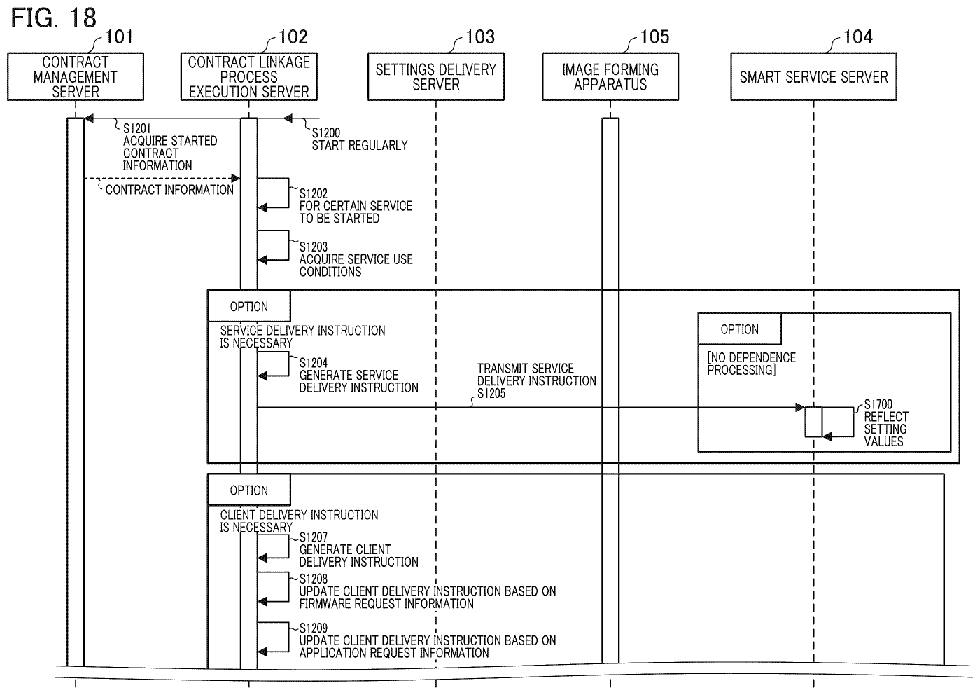

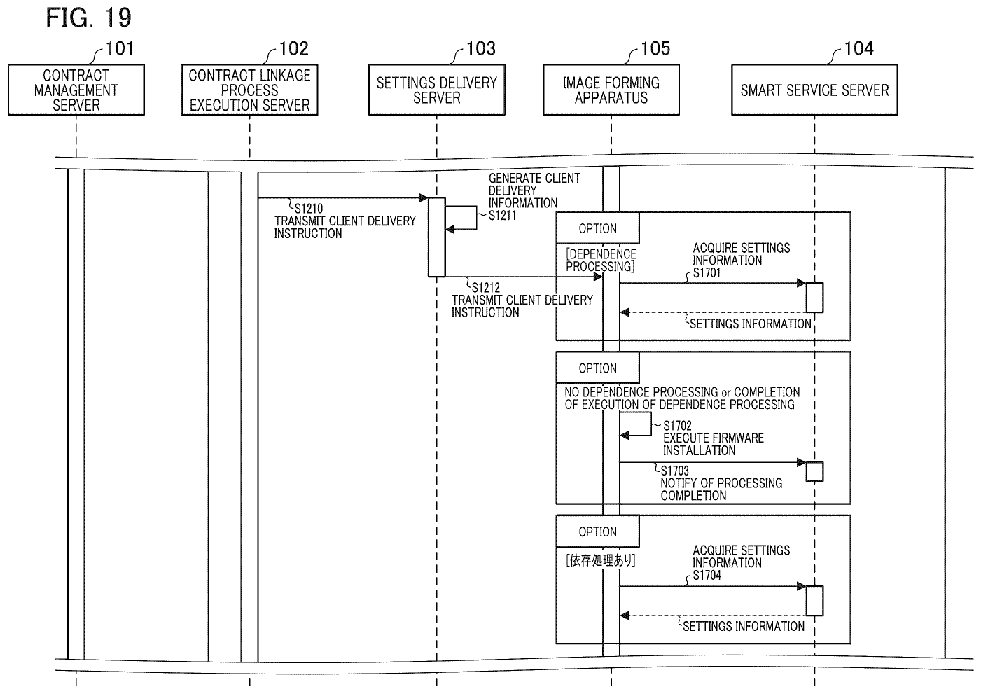

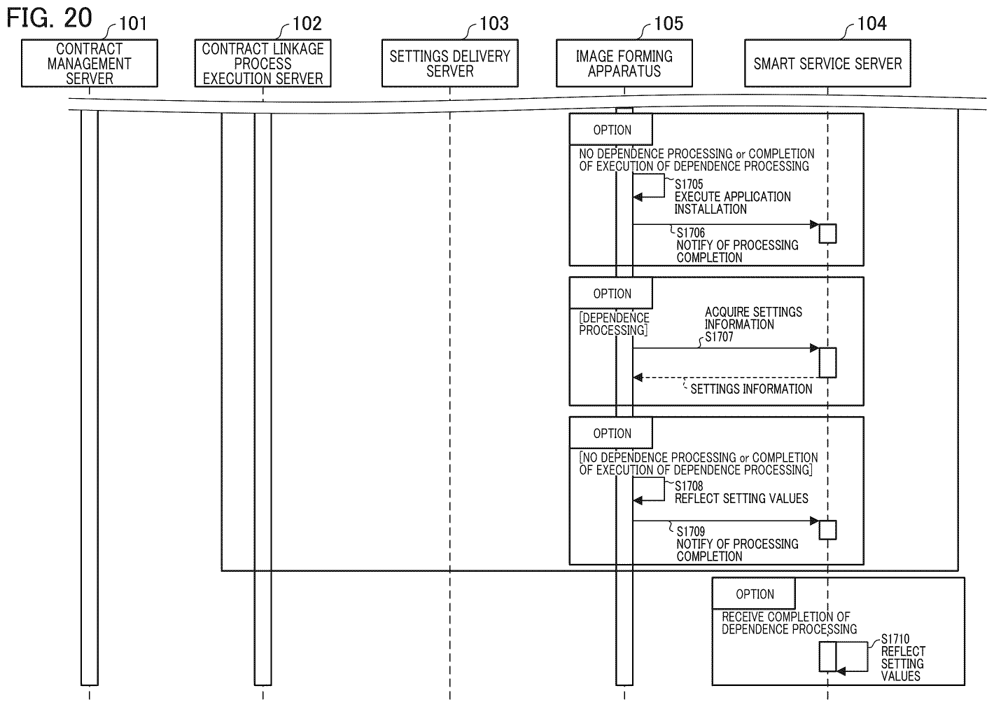

FIGS. 18, 19, and 20 are sequence diagrams illustrating examples of processes according to Example 3. FIGS. 18, 19, and 20 illustrate an entire contract linkage process in Example 3.

In step S1200, the contract linkage process execution server 102 has started periodically by a trigger started for each regular period.

In step S1201, the contract linkage process execution server 102 acquires a contract of which a contract period has started from the contract management server 101 by the contract determination function 503. The contract linkage process execution server 102 determines whether the contract period has started by the contract period detection function 501. Here, a loop process is executed from the contract acquired here and a smart service included in the contract, but is omitted in FIGS. 18, 19, and 20 for simplification.

In step S1202, the contract linkage process execution server 102 represents a process for a specific smart service while the loop process is being executed.

In step S1203, the contract linkage process execution server 102 acquires the service use conditions of the smart service from the service use condition management function 502 by the contract determination function 503.

In step S1204, the contract linkage process execution server 102 generates a service delivery instruction based on the service request settings information by the contract determination function 503 when the use conditions of the target smart service include the service request settings information.

In step S1205, the contract linkage process execution server 102 transmits the generated service delivery instruction to the smart service server 104 by the contract determination function 503.

In step S1700, the smart service server 104 reflects and retains the service setting values when the setting management function 702 does not have the dependence processing with reference to the service delivery instruction. In step S1700, when the setting management function 702 has the dependence processing with reference to the service delivery instruction, the smart service server 104 waits until a dependence processing completion notification is received from the image forming apparatus 105.

In step S1207, when the use conditions of the target smart service include the client request settings information, the contract linkage process execution server 102 generates the client delivery instruction based on the client request settings information by the contract determination function 503.

In step S1208, when the use conditions of the target smart service include the firmware request information, the contract linkage process execution server 102 updates the client delivery instruction based on the firmware request information by the contract determination function 503.

In step S1209, when the use conditions of the target smart service include the application request information, the contract linkage process execution server 102 updates the client delivery instruction based on the application request information by the contract determination function 503.

In step S1210, the contract linkage process execution server 102 transmits the generated client delivery instruction to the settings delivery server 103 by the contract determination function 503.

In step S1211, the settings delivery server 103 generates the client delivery information based on the client delivery instruction by the setting instruction determination function 601.

In step S1212, the settings delivery server 103 transmits the client delivery instruction to the image forming apparatus 105 by the setting instruction determination function 601. The image forming apparatus 105 refers to the client delivery information by the firmware installation function 802.

In step S1701, when the client firmware information included in the client delivery information has the dependence processing, the image forming apparatus 105 acquires the service settings information from the smart service server 104 by the firmware installation function 802.

In step S1702, when the dependence processing is reflected in the acquired service settings information, the image forming apparatus 105 executes the firmware installation by the firmware installation function 802. Alternatively, in step S1702, when the client firmware information does not have the dependence processing, the image forming apparatus 105 executes the firmware installation by the firmware installation function 802.

In step S1703, the image forming apparatus 105 transmits a completion notification of the firmware installation process to the smart service server 104 by the firmware installation function 802.

In step S1704, when the client application information included in the client delivery information has the dependence processing, the image forming apparatus 105 acquires the service settings information from the smart service server 104 by the application installation function 803. Step S1704 may not be executed when it is known that the dependence processing has been completed by the service settings information acquired in step S1701.

In step S1705, when the dependence processing is reflected in the acquired service settings information, the image forming apparatus 105 executes the application installation by the application installation function 803. Alternatively, in step S1705, when the client application information does not have the dependence processing, the image forming apparatus 105 executes the application installation by the application installation function 803.

In step S1706, the image forming apparatus 105 transmits a completion notification of the application installation process to the smart service server 104 by the application installation function 803.

In step S1707, when the client settings information included in the client delivery information has the dependence processing, the image forming apparatus 105 acquires the service settings information from the smart service server 104 by the setting management function 801. Step S1707 may not be executed when it is known that the dependence processing has been completed by the service settings information acquired in step S1701 or S1704.

In step S1708, when dependence processing is reflected in the acquired service settings information or when the client settings information does not have the dependence processing, the image forming apparatus 105 executes reflection of the setting values by the setting management function 801.

In step S1709, the image forming apparatus 105 transmits a completion notification of the setting value reflection process to the smart service server 104 by the setting management function 801.

When the service delivery instruction to the smart service server 104 has the dependence processing and the process of step S1700 is not executed, the smart service server 104 waits for transmission of the dependence processing completion notification from the image forming apparatus 105 by the setting management function 702. The smart service server 104 receives the process completion notification from the image forming apparatus 105 by the setting management function 702 and confirms whether a process is the dependence processing during the waiting in steps S1703, S1706, and S1709.

In step S1710, the smart service server 104 executes the reflection of the setting values by the setting management function 702 when the process completion notification is a completion notification of the dependence processing during the waiting.

### Example 4

In description of Example 4, only differences from Example 1 will be described. In Example 4, execution of a service delivery instruction in the smart service server 104 and execution of a client delivery instruction in the image forming apparatus 105 are controlled according to presence or absence of a service use agreement of a customer included in contract information.

In Example 4, the contract linkage process execution server 102 executes control using service use agreement information of a customer retained in the contract information described in Instance 1. In Instance 1, a CustomerAgreement attribute indicates the agreement information. The service use agreement information is delivered to the smart service server 104 and the image forming apparatus 105 through a service delivery instruction, a client delivery instruction, and client delivery information. In Example 4, the smart service server 104 executes service setting value delivery based on the service use agreement information of the customer. In Example 4, the image forming apparatus 105 executes client setting value delivery, firmware installation, and application installation based on the service use agreement information of the customer.

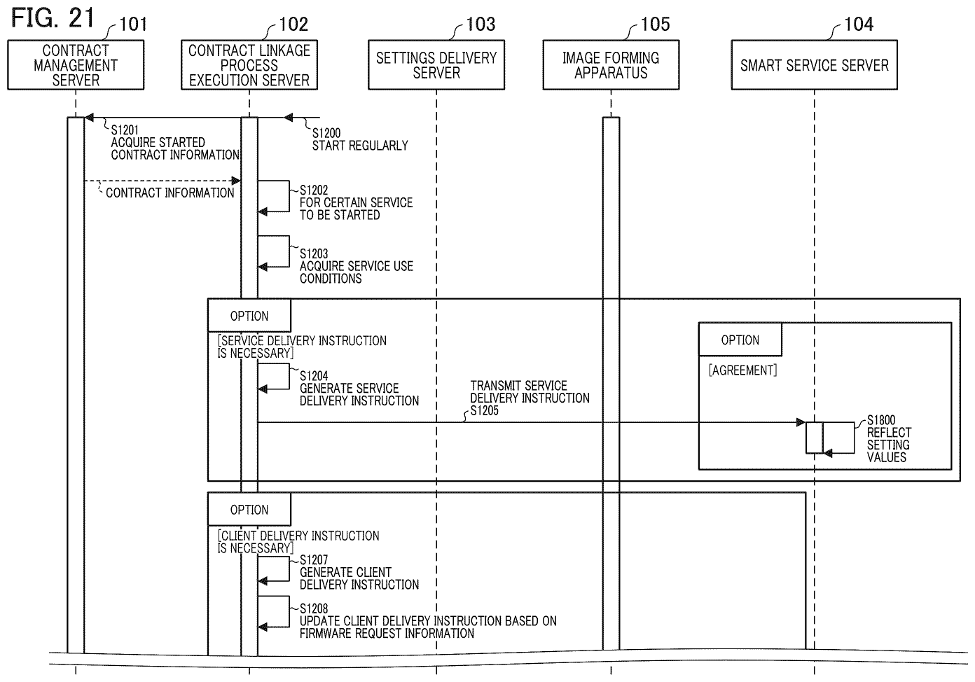

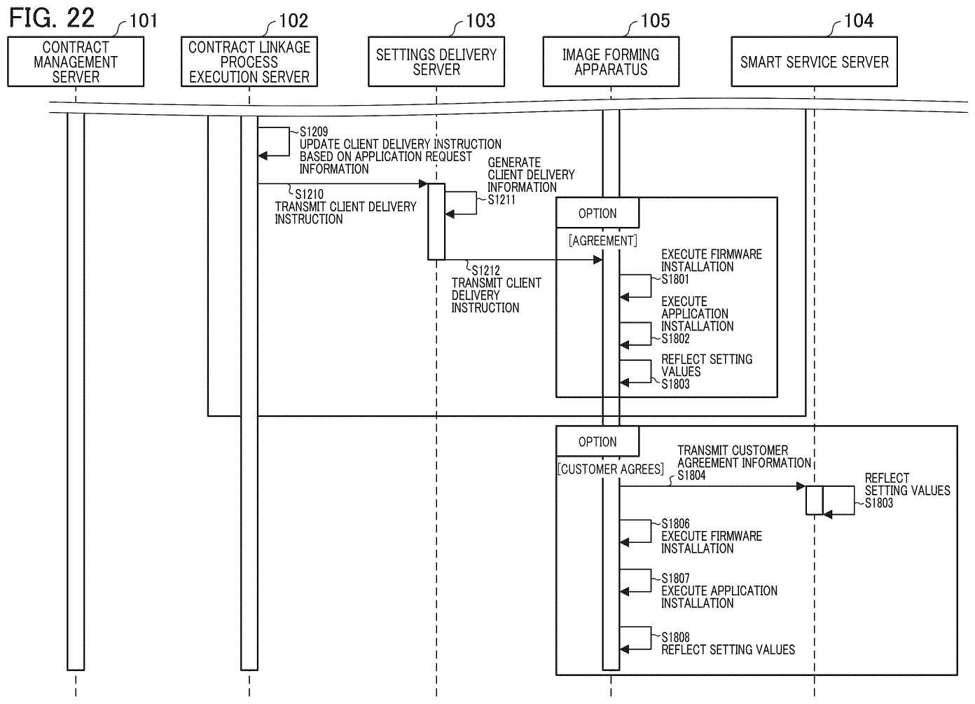

FIGS. 21 and 22 are sequence diagrams illustrating an example of a process according to Example 4.

In step S1200, the contract linkage process execution server 102 has started periodically by a trigger started for each regular period.

In step S1201, the contract linkage process execution server 102 acquires a contract of which a contract period has started from the contract management server 101 by the contract determination function 503. The contract linkage process execution server 102 determines whether the contract period has started by the contract period detection function 501. Here, a loop process is executed from the contract acquired here and a smart service included in the contract, but is omitted in FIGS. 21 and 22 for simplification.

In step S1202, the contract linkage process execution server 102 represents a process for a specific smart service while the loop process is being executed.

In step S1203, the contract linkage process execution server 102 acquires the service use conditions of the smart service from the service use condition management function 502 by the contract determination function 503.

In step S1204, the contract linkage process execution server 102 generates a service delivery instruction based on the service request settings information by the contract determination function 503 when the use conditions of the target smart service include the service request settings information.

In step S1205, the contract linkage process execution server 102 transmits the generated service delivery instruction to the smart service server 104 by the contract determination function 503.

In step S1800, the smart service server 104 reflects and retains the service setting values by the setting management function 702 in response to the received service delivery instruction when the agreement of the customer agreement information included in the service delivery instruction is completed.

In step S1207, when the use conditions of the target smart service include the client request settings information, the contract linkage process execution server 102 generates the client delivery instruction based on the client request settings information by the contract determination function 503.

In step S1208, when the use conditions of the target smart service include the firmware request information, the contract linkage process execution server 102 updates the client delivery instruction based on the firmware request information by the contract determination function 503.

In step S1209, when the use conditions of the target smart service include the application request information, the contract linkage process execution server 102 updates the client delivery instruction based on the application request information by the contract determination function 503.

In step S1210, the contract linkage process execution server 102 transmits the generated client delivery instruction to the settings delivery server 103 by the contract determination function 503.

In step S1211, the settings delivery server 103 generates the client delivery information based on the client delivery instruction by the setting instruction determination function 601.

In step S1212, the settings delivery server 103 transmits the generated client delivery instruction to the image forming apparatus 105 by the setting instruction determination function 601.

In step S1801, when the customer agreement information included in the service delivery instruction indicates an agreement completion state, the image forming apparatus 105 executes firmware installation in accordance with the client delivery information by the firmware installation function 802.

In step S1802, when the customer agreement information included in the service delivery instruction indicates the agreement completion state, the image forming apparatus 105 executes application installation in accordance with the client delivery information by the application installation function 803.

In step S1803, when the customer agreement information included in the service delivery instruction indicates the agreement completion state, the image forming apparatus 105 reflects and retains the client setting values by the setting management function 801 in accordance with the client delivery information.

In step S1804, when the customer agreement information included in the service delivery instruction does not indicate the agreement completion state and a customer agrees about use of the service via the user interface of the image forming apparatus 105, the image forming apparatus 105 executes a subsequent process. That is, in step S1804, in this case, the image forming apparatus 105 transmits the customer agreement information to the smart service server 104 by the setting management function 801.

In step S1805, in the smart service server 104 receives the customer agreement information by the setting management function 702 and executes reflection of the service setting values.

In step S1806, the image forming apparatus 105 executes the firmware installation by the firmware installation function 802.

In step S1807, the image forming apparatus 105 executes application installation by the application installation function 803.

In step S1808, the image forming apparatus 105 reflects and retains the client setting values by the setting management function 801.

In any of Examples 1 to 4, the same number of servers as the number in the entire configuration illustrated in FIG. 1 may not be necessarily included. Specifically, the plurality of image forming apparatuses 105 may receive a delivery instruction. The plurality of smart service servers 104 may receive the delivery instruction.

In Examples 1 to 4, the processes linked with the start of the service use contract have been described. However, through similar processes in any of Examples 1 to 4, processes linked with contract update in association with addition of a new service contract can also be executed.

The above-described use contract may include service use setting values for each customer. In this case, at least one of a service delivery instruction and a client delivery instruction transmitted when the contract linkage process execution server determines to start a period of the use contract is an instruction that is based on the service use setting values for each customer.

When there are initial setting values registered in association with the use contract in advance, the contract linkage process execution server 102 may transmit the service delivery instruction and the client delivery instruction based on the initial setting values.

Upon determining that the use contract has been updated, the contract linkage process execution server 102 may execute the transmission of the service delivery instruction related to unsetting content to the smart service server 104. Upon determining that the use contract has been updated, the contract linkage process execution server 102 may execute transmission of the client delivery instruction related to the unsetting content to the settings delivery server 101.

The contract linkage process execution server 102 may receive contract period start information indicating start of the use contract from the contract management server 101 via the external communication function 500.

### Other Embodiments

Some of the elements configured in the present disclosure can also be realized in a process of supplying a program that realizes one or more functions according to the above-described embodiment to a system or an apparatus via a network or a recording medium and causing one or more processors of a computer of the system or the apparatus to read and execute the program. Some of the elements configured in the present disclosure can also be realized by a circuit that realizes one or more functions, for example, an application specific integrated circuit (ASIC).

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-15993, filed Feb. 5, 2024, which is hereby incorporated by reference wherein in its entirety.

1. An information processing system comprising a contract management server, a contract linkage process execution server, a settings delivery server, a smart service server, and an image forming apparatus,
wherein the contract management server executes a contract management function to manage a use contract of a smart service,
wherein the contract linkage process execution server executes a contract determination function that determines the managed use contract,
wherein the settings delivery server executes client settings information management function that manages settings information of the image forming apparatus, and
wherein the contract linkage process execution server comprises,
one or more memories storing instructions, and
one or more processors capable of executing the instructions causing the contract linkage process execution server to:
upon determining that a period of the use contract has started or the use contract has been updated, automatically execute (1) transmission of a client delivery instruction to the settings delivery server and (2) transmission of a service delivery instruction to the smart service server, and
wherein the client delivery instruction is based on setting information related to application and firmware required on the image forming apparatus to use the smart service, and
wherein the service delivery instruction is based on service request settings to be reflected in service setting values for the smart service of the smart service server.

2. The information processing system according to claim 1,
wherein the contract management server has an external communication function of communicating with an external side, and
wherein the contract linkage process execution server receives contract period start information indicating start of the use contract from the contract management server through the external communication function.

3. The information processing system according to claim 1,
wherein the contract linkage process execution server further has a service use condition management function that manages a use condition associated with using the smart service, and
wherein the contract linkage process execution server, without the transmission of the service delivery instruction when the service request settings are not included as the use condition, transmits the service delivery instruction when the service request settings are included as the use condition.

4. The information processing system according to claim 1, wherein at least one of the service delivery instruction and the client delivery instruction transmitted from the contract linkage process execution server upon determining that a period of the use contract has started is an instruction that is based on a service use setting value of each of the customers.

5. The information processing system according to claim 1,
wherein the image forming apparatus executes client setting value delivery, firmware installation, and application installation in conformity with the client delivery instruction under order control.

6. A method in an information processing system including an image forming apparatus, a contract management server for executing a contract management function to manage a use contract of a smart service, a contract linkage process execution server, a settings delivery server for executing client settings information management function that manages settings information of the image forming apparatus, and a smart service server for providing the smart service, the method comprising:
determining, by the contract linkage process execution server, the managed use contract; and
upon determining that a period of the use contract has started or the use contract has been updated, automatically executing, by the contract linkage process execution server, (1) transmission of a client delivery instruction to the settings delivery server and (2) transmission of a service delivery instruction to the smart service server,
wherein the client delivery instruction is based on setting information related to application and firmware required on the image forming apparatus to use the smart service, and
wherein the service delivery instruction is based on service request settings to be reflected in service setting values for the smart service of the smart service server.
